(19) United States
(12) Patent Application Publication
(10) Pub. No.: US 2012/0246084 A1
(43) Pub. Date: Sep. 27, 2012

(54) Systems and Methods for Real Estate Documentation Preparation

(76) Inventor: Ryan Marshall, Huntington Beach, CA (US)

(21) Appl. No.: 13/070,228

(22) Filed: Mar. 23, 2011

(51) Int. Cl. G06Q 50/00

(52) U.S. Cl. 705/313

(57) ABSTRACT

Systems and methods are disclosed which allow for the electronic completion of the various documents, such as real estate disclosure documents. A seller of real estate may log into a web-based portal or application to view a list of the disclosure documents. The seller may then electronically answer questions related to the various real estate disclosure documents. Based on the answers supplied by the seller, an electronic document suitable for execution may be generated.

### BACKGROUND

The disclosure of real estate conditions is often a critical element in any real property transaction and plays an increasingly important role for property owners and their attorneys, agents, brokers, appraisers, inspectors and other consultants. Federal and state laws, lender policies and regulations, as well as demands by prospective buyers create a considerable demand for the full disclosure of potential detrimental conditions and other information related to the property. Notwithstanding government requirements, there are several reasons that a full real estate disclosure is beneficial. Buyers obtain better knowledge of what they are purchasing, and a full disclosure helps shield sellers, brokers and appraisers from future liability. Also, lenders obtain a better understanding of their collateral assets.

### BRIEF DESCRIPTION OF THE DRAWINGS

The present disclosure will be more readily understood from a detailed description of some example embodiments taken in conjunction with the following figures:

FIG. 1 illustrates an example computer-based document preparation system in accordance with one non-limiting embodiment.

FIG. 2 illustrates a flowchart of an example document preparation process in accordance with one non-limiting embodiment.

FIG. 3 illustrates a flowchart of an example real estate disclosure document preparation process in accordance with one non-limiting embodiment.

FIGS. 4 and 5 are diagrams of an example user interface in accordance with one non-limiting embodiment.

FIG. 6 shows a completed electronic real estate disclosure document in accordance with one non-limiting embodiment.

FIG. 7 is a diagram of an example user interface in accordance with one non-limiting embodiment.

FIG. 8 is a time-base illustration of first user-side and second user-side interactions with a document preparation server in accordance with one non-limiting embodiment.

### DETAILED DESCRIPTION

Various non-limiting embodiments of the present disclosure will now be described to provide an overall understanding of the principles of the structure, function, and use of the document preparation systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Real estate disclosure documents are typically completed by a seller of real property when the seller wishes to sell the piece of real property. Real estate disclosure documents may include, for example, documents that generally relate to the disclosure of conditions that might impact property values or purchase decisions. Typically, the seller must complete a relatively large volume of disclosure documents prior to entering into a sales transaction. This process may be logistically difficult, as the seller must receive hardcopies of the documents from a real estate professional, fill them out, sign them, and then return the copies to the real estate professional assisting them with the sale of their property. Even if the seller wishes to execute and transmit the documents electronically to the real estate professional, the seller may not have access to a printer, fax machine, a scanner, or other necessary equipment to electronically transmit the documents. In some cases, the seller may not understand the documents they are executing, such as when the document is not prepared in their native language or if the document is related to a relatively complicated topic, for example. Along those same lines, the disclosure documents may also use words or phrases that are unfamiliar to the seller. To complicate matters, there does not exist a single, universal disclosure report for all types of real estate transactions in all jurisdictions. In fact, the disclosure documents might differ on a state-to-state basis, a county-to-county basis, or even a municipality-to-municipality basis. The disclosure documents may also based on property type (e.g., residential, commercial, real estate, etc.) The real estate professional working with the seller typically must decide which documents are required by the seller.

The presently disclosed example embodiments are generally directed to systems and methods for electronic document preparation. Such systems and methods may be implemented in a wide variety of contexts. In one example embodiment, the presently disclosed system and methods allow for electronic completion of the various disclosure documents associated with a real estate transaction by a seller of real property. As discussed in more detail below, in some example embodiments, a real estate professional may log into or otherwise access a web-based portal or application to supply various details regarding a piece of real estate (e.g., address, year built, etc.). The details may uniquely identify the real property, such as a parcel number, a lot number, coordinates, and the like. Subsequently, the seller of the property may securely log into or otherwise access a web-based portal or application to view an electronic aggregation of the disclosure documents associated with the real estate. The seller may then electronically answer questions related to the various real estate disclosure documents related to their property. In some example embodiments, web-based links may be graphically provided to the seller to provide additional information (e.g., links to federal or state regulations, links to dictionaries, etc.) in order to assist in the document completion process. Key words or phrases in the various questions may be indicated to the seller as “target terms.” The seller may be provided with a definition, or other types of explanation, for these target terms. In some example embodiments, the questions, as electronically presented to the seller, may be prepared in one of a variety of languages in order to aid in the comprehension of the disclosure document by the seller.

In some example embodiments, as the seller is answering the questions, or otherwise completing the disclosure documents, the real estate professional may be able to remotely view the seller's status in real-time, or near real-time, via their web portal. As discussed in more detail below, while the real estate professional may not have the ability to submit an answer, they still can view the status of the completion process and offer advice or answer the seller's questions. Once the seller has completed the requisite questions for a particular disclosure document, the document preparation system may generate an electronic version of the disclosure document with various information pre-populated into the electronic version. The pre-populated information may include information culled from the real estate information provided by the real estate professional (e.g., the address of the property) and the responses provided to the questions by the seller. In one example embodiment, the electronic version is a printable version of the disclosure document in .pdf format. In other example embodiments, other formats may be used, just as .jpeg or .bmp, for example. In any event, the electronic version may subsequently be executed by the seller. The electronic version may be in a different language than the language in which the questions were originally presented to the seller.

Generally, the presently disclosed system and methods allow for a wide variety of documents to be completed by a user. For the purposes of illustration, the present disclosure will largely be described in the context of real estate disclosure documents related to a piece of real property, although this disclosure is not so limited. For example, in various embodiments the present disclosure accommodate any of a wide variety of documentation, standardized forms, custom forms, contracts, agreements, and the like associated with a real estate transaction. While the term “seller” is used below, the disclosure is not limited to any particular type of user. Instead, the “seller” in the various example embodiments may refer to any type of user using the systems and methods to complete documents or forms. Furthermore, the “sellers” referred to in the example embodiments below are not limited to actual sellers of the real estate, but may also include anyone with knowledge of the property, such as property managers, and the like. Similarly, the term “real estate professional,” as used herein, is not intended to be limiting, but rather is used to encompass any type of personnel who might use the systems and methods, such as listing agents, brokers, real estate agents, and the like. For the sake of convenience, many examples used herein are in the context of a single family dwelling unit, although this disclosure is not so limited. The systems and methods may be used in connection with a wide variety of real estate, such as single family dwelling units, multiple family dwelling units, land, and commercial properties, for example.

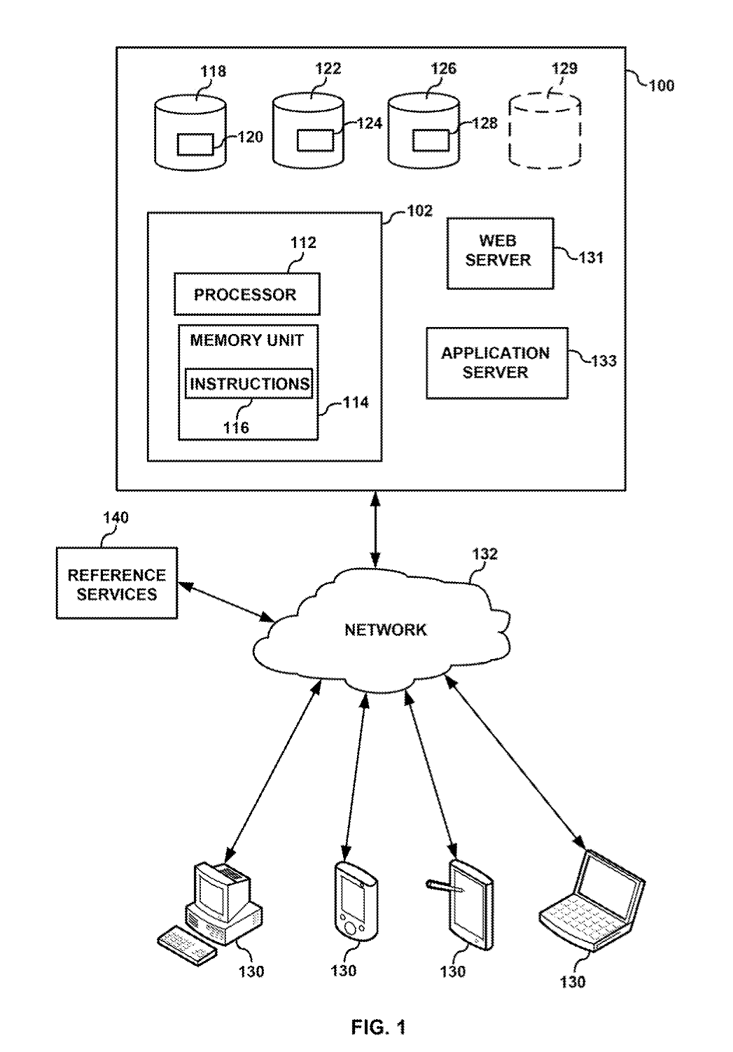

Referring now to FIG. 1, one example embodiment of the present disclosure may comprise a computer-based document preparation system 100 that is configured to generate documents based on inputs from various users, such as a sellers and real estate professionals. The document preparation system 100 may be provided using any suitable processor-based device or system, such as a personal computer, laptop, server, mainframe, or a collection (e.g., network) of such computer devices, for example. The document preparation system 100 may comprise a computer device 102 that may include one or more processors 112 and one or more computer memory units 114. For convenience, only one processor 112 and only one memory unit 114 are shown in FIG. 1. The processor 112 may execute software instructions 116 stored in the memory unit 114. The processor 112 may be implemented as an integrated circuit (IC) having one or multiple cores. The memory unit 114 may include volatile and/or non-volatile memory units. Volatile memory units may include random access memory (RAM), for example. Non-volatile memory units may include read only memory (ROM), for example, as well as mechanical non-volatile memory systems, such as, for example, a hard disk drive, an optical disk drive, etc. The RAM and/or ROM memory units may be implemented as discrete memory ICs, for example.

When the processor 112 of the document preparation system 100 executes the instructions 116, the processor 112 may be caused to perform the various operations of the document preparation system 100, such as receive real estate data, display data regarding real estate disclosure documents, receive inputs from a seller, generate populated disclosure forms, and monitor the status of various processes, as discussed in more detail below. Data used by the document preparation system 100 may be from various sources, such as disclosure database 118, which may be an electronic computer database, for example, that stores data about various disclosure documents. The data stored in the disclosure database 118 may be stored in a non-volatile computer memory 120, such as a hard disk drive, a read only memory (e.g., a ROM IC), or other types of non-volatile memory. Data may also be stored in a property database 122, which may be an electronic computer database, for example, that stores data about real property, such as addresses, names of sellers, year of construction, etc. The data stored in the property database 122 may be stored in a non-volatile computer memory 124, such as a hard disk drive, a read only memory (e.g., a ROM IC), or other types of non-volatile memory. Data may also be stored in a log database 126, which may be an electronic computer database, for example. The data stored in the log database 126 may be stored in a non-volatile computer memory 128, such as a hard disk drive, a read only memory (e.g., a ROM IC), or other types of non-volatile memory. The log database 126 may store data regarding user activity. As is to be appreciated, various types of data may also be stored in other databases, such as a distribution channel database and a scheduling system database, as indicated by database 129.

As shown in FIG. 1, the document preparation system 100 may include several computer servers. For example, the document preparation system 100 may include one or more web servers 131 and application servers 133. For convenience, only one web server 131 and one application server 133 are shown in FIG. 1, although it should be recognized that the invention is not so limited. The web server 131 may provide a graphical web user interface through which users of the system may interact with the document preparation system 100. The web server 131 may accept requests, such as HTTP requests, from a user (such as web browsers on a user device 130), and serve the user, such as HTTP responses, along with optional data content, such as web pages (e.g., HTML documents) and linked objects (such as images, etc.). The application server 133 may provide a user interface for users who do not communicate with the document preparation system 100 using a web browser. Such users may have special software installed on their user devices 130 that allows them to communicate with the application server 133 via the network 132. Such software may be downloaded, for example, from the document preparation system 100, or other software application provider, over the network to such user devices 130. The software may also be installed on such user devices 130 by other means known in the art, such as CD-ROM, etc.

The servers 131 and 133 may comprise processors (e.g., CPUs), memory units (e.g., RAM, ROM), non-volatile storage systems (e.g., hard disk drive systems), etc. The servers 131 and 133 may utilize operating systems, such as Solaris, Linux, or Windows Server operating systems, for example.

The document preparation system 100 may be in communication with user devices 130 via an electronic communications network 132. The communications network 132 may include a number of computer and/or data networks, including the Internet, LANs, WANs, GPRS networks, etc., and may comprise wired and/or wireless communication links. The user devices 130 may communicate with the document preparation system 100 and may be any type of client device suitable for communication over the network 132, such as a personal computer, a laptop computer, or a netbook computer, for example. In some example embodiments, a user may communicate with the network 132 via a user device 130 that is a combination handheld computer and mobile telephone, sometimes referred to as a smart phone. It can be appreciated that while certain embodiments may be described with users communication via a smart phone or laptop by way of example, the communication may be implemented using other types of user equipment (UE) or wireless computing devices such as a mobile telephone, personal digital assistant (PDA), combination mobile telephone/PDA, handheld device, mobile unit, subscriber station, game device, messaging device, media player, pager, or other suitable mobile communications devices.

The user device 130 may provide a variety of applications for allowing a user to accomplish one or more specific tasks using the document preparation system 100. Applications may include, without limitation, a web browser application (e.g., INTERNET EXPLORER, MOZILLA, FIREFOX, SAFARI, OPERA, NETSCAPE NAVIGATOR), telephone application (e.g., cellular, VoIP, PTT), networking application, messaging application (e.g., e-mail, IM, SMS, MMS, BLACKBERRY Messenger), contacts application, calendar application, and so forth. The user device 130 may comprise various software programs such as system programs and applications to provide computing capabilities in accordance with the described embodiments. System programs may include, without limitation, an operating system (OS), device drivers, programming tools, utility programs, software libraries, application programming interfaces (APIs), and so forth. Exemplary operating systems may include, for example, a PALM OS, MICROSOFT OS, APPLE OS, UNIX OS, LINUX OS, SYMBIAN OS, EMBEDIX OS, Binary Run-time Environment for Wireless (BREW) OS, JavaOS, a Wireless Application Protocol (WAP) OS, and others.

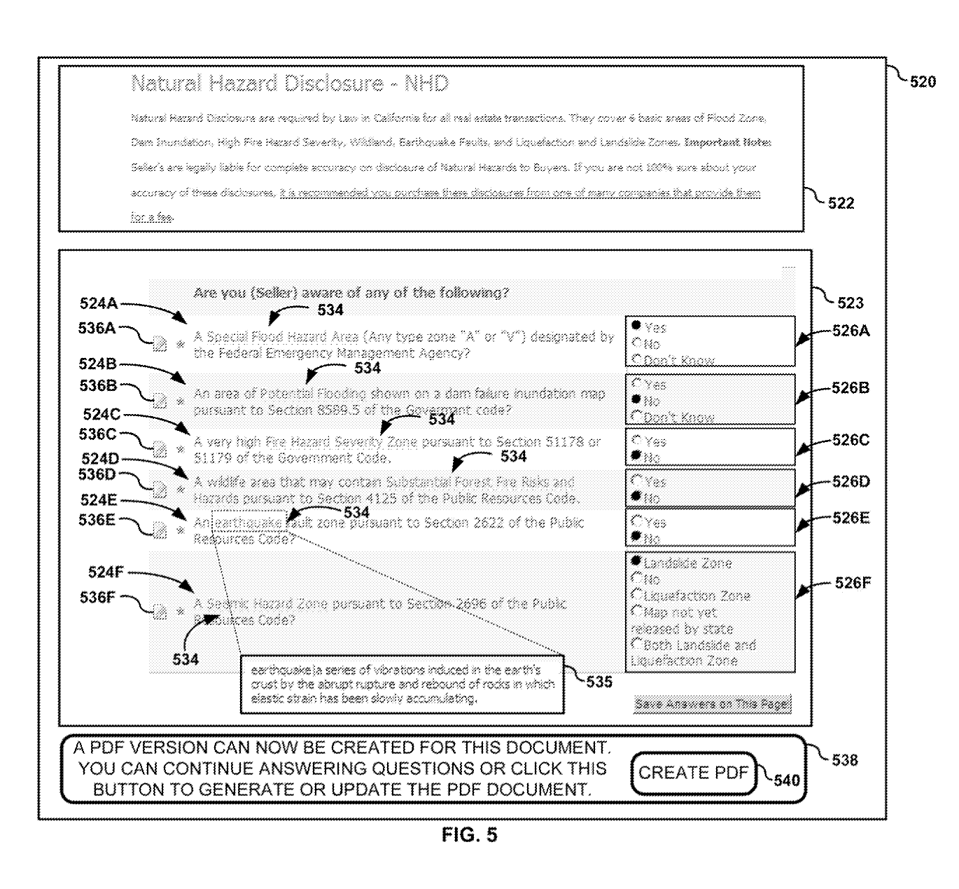

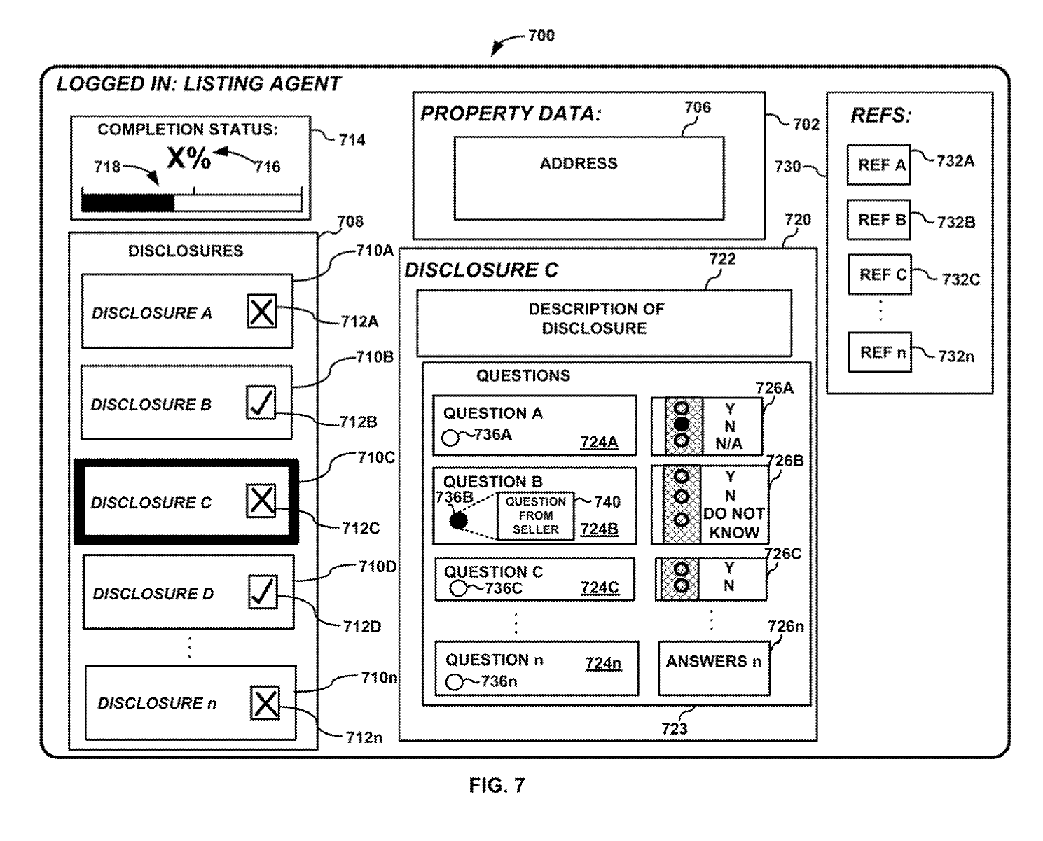

In general, an application may provide a user interface to communicate information between the document preparation system 100 and the users via user devices 130. The user devices 130 may include various components for interacting with the application such as a display for presenting the user interface and a keypad for inputting data and/or commands. The user devices 130 may include other components for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, a camera, and so forth. Example user interfaces are shown in FIGS. 4 and 7, which are described further below. Through the interface, the users may interact with the document preparation system 100. Additionally, users may interact with the document preparation system 100 via a variety of other electronic communications techniques, such as email messages and short message service (SMS) messages. The applications may include or be implemented as executable computer program instructions stored on computer-readable storage media such as volatile or non-volatile memory capable of being retrieved and executed by a processor to provide operations for the user devices 130. The memory may also store various databases and/or other types of data structures (e.g., arrays, files, tables, records) for storing data for use by the processor and/or other elements of the user devices 130.

In addition to the end user devices 130, the document preparation system 100 may be in communication with other entities, such as a reference services 140, for example. The reference services 140 may be third-party providers of information, such as online dictionaries and online repositories of statutes, for example.

Although FIG. 1 depicts a limited number of elements for purposes of illustration, it can be appreciated that the document preparation system 100 may include more or less elements as well as other types of elements in accordance with the described example embodiments. Elements of the document preparation system 100 may include physical or logical entities for communicating information implemented as hardware components (e.g., computing devices, processors, logic devices), executable computer program instructions (e.g., firmware, software) to be executed by various hardware components, or combination thereof, as desired for a given set of design parameters or performance constraints.

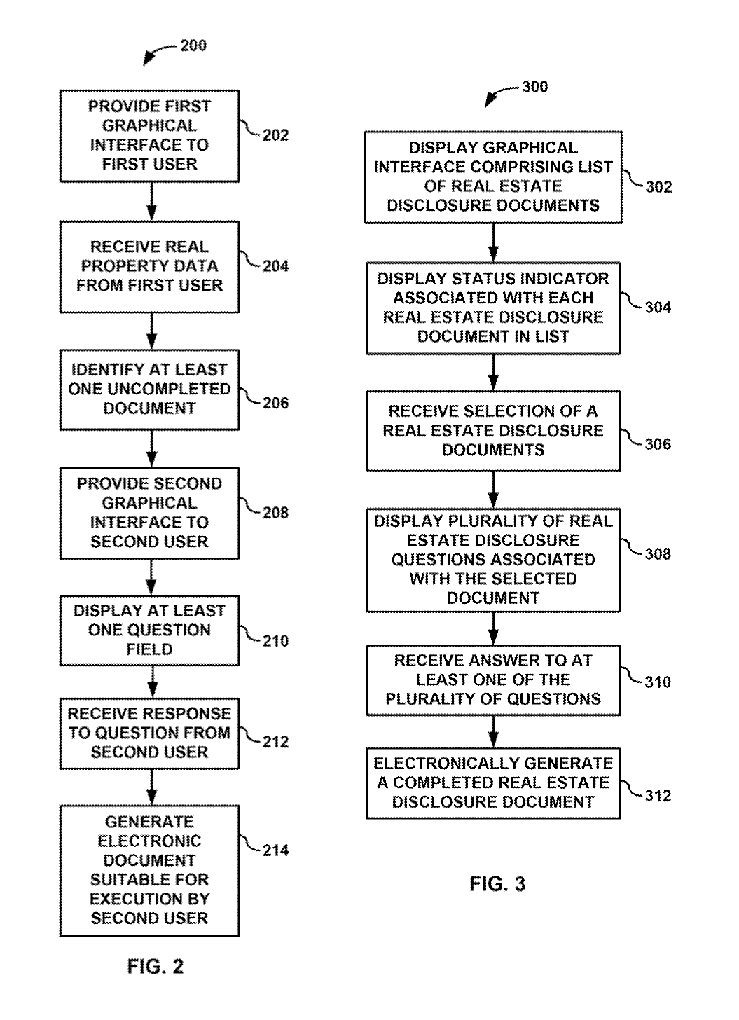

FIG. 2 illustrates a document preparation process 200 in accordance with one non-limiting embodiment. Referring now to FIGS. 1 and 2, the document preparation process 200 may be executed, at least in part, by the computer device 102. At block 202, a first graphical interface may be provided to a first user. The web server 131 may be used to host the graphical interface or otherwise allow communication with the first user. The first graphical interface may be viewed, for example, on a user device 130 (FIG. 1). The first user may be, without limitation, a real estate professional. The first graphical interface may require the first user to provide credentials (i.e., username and password) to access various portions of the graphical interface. At block 204, real property data may be received from the first user via the first graphical interface. The real property data may be indicative of an address, a year of construction, and/or any other information that may be needed by the document preparation system 100. The real property data may be stored in the property database 122. In some example embodiments, the document preparation system 100 can check the real property data against an information source and provide a notification if there is a discrepancy. For example, the document preparation system 100 may compare the real property data against publicly available information (title information, tax information, zoning information, etc.) and generate a flag if there is a disagreement between the entered data and the publicly available data. At block 206, the document preparation system 100 may identify at least one uncompleted document, such as a real estate disclosure document. The determination by the document preparation system 100 as to which documents are required may be based at least in part on the address of the property, the year of the construction of the real property, and/or other information regarding the property (e.g., parcel number, lot number, property type, etc.). For example, real property constructed before a certain year may require certain types of disclosures and real property located in certain geographic areas may require certain disclosures. Information regarding the various disclosure documents may be stored in the disclosure database 118.

Still referring to FIGS. 1 and 2, at block 208, a second graphical interface may be provided to a second user. The web server 131 may be used to host the graphical interface or otherwise allow communication with the second user. The second graphical interface may be viewed, for example, on a user device 130 (FIG. 1). The first user may be, without limitation, a seller of the property or other person having knowledge of the real property. In various example embodiments, the document preparation system 100 may concurrently provide the first graphical interface to the first user and the second graphical interface to the second user, with each user viewing their respective graphical interface on their user device 130. The first user may be remotely located from the second user. At block 210, at least one question field may be displayed to the second user by the document preparation system 100. The question field may correspond to at least one question on an uncompleted real estate document. For example, the question may be related to a lead-based paint disclosure document, a natural hazard disclosure document, a seller's affidavit, and a seller property questionnaire. The second user may answer the question and, at block 212, the document preparation system 100 may receive the response to the question from the second user. The second user may provide the answer using any suitable data entry technique. In one example embodiment, for example, one or more “radio” buttons are graphically displayed to the second user on the second graphical interface which allow the second user to electronically select an answer corresponding to a particular button (e.g., “yes”, “no”, “I do not know”, “not applicable”, etc.). In some example embodiments, as the second user provides answers to various questions, the first graphical interface presented to the first user will be updated accordingly. In other words, even though the first user may not be able to enter answers to questions via their graphical interface, the first user may be able to electronically observe the second user complete the questions in real time (or near real time).

At block 214, the document preparation system 100 may generate an electronic document. The electronic document may be in a format suitable for execution by the second user. In other words, the electronic document may be signed with a physical signature, an electronic signature (e.g., via digital signature processing), or any other type of suitable execution technique. In one example embodiment, the electronic document is a completed real estate disclosure document that is populated with the answers provided by the second user. The electronic document may be in any suitable electronic format, such as .pdf (Postcript Data File) format, .tiff format, .img format, a .doc format, a .zip format, or any other suitable type of data format. The electronic document may also be populated with various information regarding the real estate, such as the address of the property. In some example embodiments, the electronic document generated by the document preparation system 100 may not require the incorporation of pre-populated information but nevertheless is suitable for execution. The electronic document may be stored by the document preparation system 100.

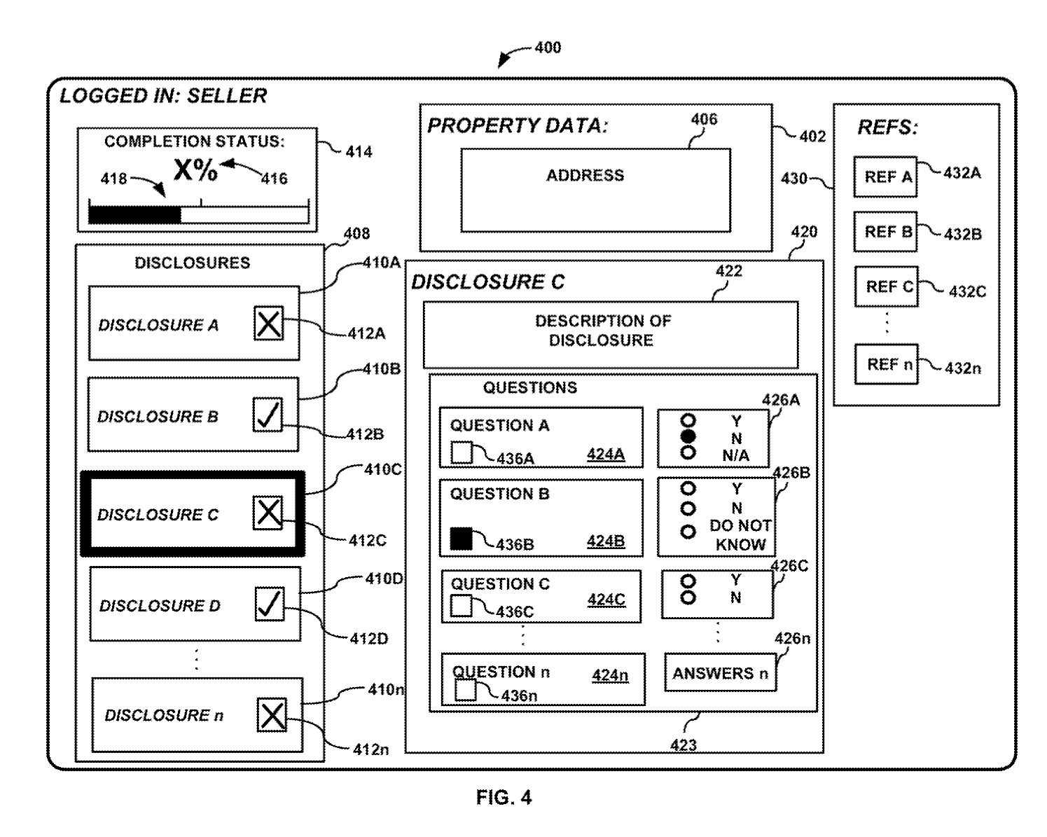

FIG. 3 illustrates a real estate disclosure document preparation process 300 in accordance with one non-limiting embodiment. Referring now to FIGS. 1 and 3, the document preparation process 300 may be executed, at least in part, by the computer device 102. At block 302, a graphical interface may be graphically displayed, such as on a user device 130, with the graphical interface comprising an aggregation of the real estate disclosure documents associated with the real estate. The web server 131 may be used to host the graphical interface. In one example embodiment, titles of each real estate disclosure document may be displayed in a list format. In other example embodiments, an aggregation of indicia associated with various real estate disclosure documents (e.g., titles, form numbers, etc.), may be presented via drop-down menu(s), a series of separate pop-up windows, or any other suitable format. For convenience, the disclosure is written primarily in the context of a “list” of the disclosure documents, although this disclosure is not so limited. The particular list of documents displayed on the graphical interface may be determined based on a variety of factors, such as the location of real estate associated with the real estate disclosure documents, the year of the construction, and the type of property, for example. At block 304, a status indicator associated with each real estate disclosure document may be displayed on the graphical interface. As is to be appreciated, a wide variety of suitable status indicators may be used. In one example embodiment, a graphical check mark is used to indicate a completed real estate disclosure document while a graphical question mark or an exclamation point is used to indicate the associated real estate disclosure document is not completed. In some example embodiments, an overall completion status is provided. The overall completion status may be expressed in terms of a percentage (e.g., “34% completed), or may be graphically expressed using a status bar, for example. By viewing the status indicators, the user can readily see which real estate disclosure documents have been completed and which ones still require attention.

At block 306, a selection of one of the real estate disclosure documents is received from a user. The user may be, for example, a seller of real property using a user device 130. Real estate disclosure documents may be selected using any suitable technique. In one example embodiment, the title of the real estate disclosure document displayed in the list is a hyper-link, while in other example embodiments various real estate disclosure documents may be selected from a drop down menu, for example. In any event, at block 308, a plurality of real estate disclosure questions may be displayed to a user via the graphical interface. The plurality of questions may be presented in one of a variety of languages. In one example embodiment, the document preparation system 100 receives an input regarding the user's native language and displays the plurality of questions in the user's native language to increase the likelihood of comprehension by the user. One of the plurality of questions may be identified by the document preparation system 100 as a target term. The target term may be, for example, underlined, bolded, or otherwise visually identified. The document preparation system 100 may receive from the user a target term definition request. The user may, for example, “hover” a mouse pointer over the target term or “click” on the target term. Once the target term definition request is received by the document preparation system 100, a definition of the target term may be graphically displayed to the user.

In some example embodiments, the graphical interface may include one or more links to additional reference services 140. The reference services 140 may include, for example, state or federal statutes, online dictionaries, video tutorials, guides, instructions, and/or other types of resources to assist the user in completing the real estate disclosure documents.

At block 310, one or more electronic answers are received from the user via the graphical interface. As described herein, the answers may be received through any suitable technique, such as through a user's selection of graphical checkboxes, a user's selection of graphical radio buttons, a user's selection from a drop down menu, or a user's input of text, for example. In some example embodiments, as the user is answering the various questions associated with the real estate disclosure documents, the document preparation system 100 is providing an indication of the user's answers to a third party. The third party may be, for example, a real estate professional associated with the user that is observing the user's completion status via a user device 130. The third party may be able to electronically view the questions associated with the various real estate disclosure documents and see how the user answered the questions. The third party may not have the ability to electronically submit the answers via their user device 130. In some situations, the user completing the various real estate disclosure documents may be in telephonic communication with their listing agent. The listing agent may view the user's completion status and offer advice via telephone regarding various questions, for example. In some example embodiments, the user may complete the real estate disclosure documents while not in telephonic communication with their listing agent. If the user has an issue regarding a questions, the user may be able to graphically “flag” or otherwise identify the question. The listing agent may then be able to subsequently view the identified questions via a graphical interface and offer advice to the user.

At block 312, the document preparation system 100 generates a completed real estate disclosure document that is populated with at least one or more of the answers received from the user. The completed real estate disclosure form may be stored by the document preparation system 100. The document preparation system 100 may also change the status indicator for that particular real estate disclosure document to indicate to the user that the document has been completed. In some example embodiment, once the user has successfully completed all of the real estate disclosure documents, the document preparation system 100 may transmit a completion notification to a third party, such as the seller's listing agent, for example.

FIG. 4 shows a screen shot of a seller user interface 400 that a user may view when they access the document preparation system 100 from their user devices 130. The seller user interface 400 may be provided by the web server 131 or the application server 133, as the case may be, depending on the user's access method. In the illustrated example embodiment, the seller user interface 400 is to be displayed to a seller of property to convey information to the seller and receive information from the seller. It is to be appreciated, however, that the present disclosure is not limited to the arrangement and content of seller user interface 400 illustrated in FIG. 4.

The seller user interface 400 may comprise a property data field 402. The property data field 402 may display various data regarding the real estate, such as an address 406. The seller user interface 400 may also comprise a disclosure list 408. The disclosure list 408 may identify a plurality of disclosures 410A-n. The particular disclosures included in the disclosure list 408 may vary by property. For example, real estate that was built before a certain date may require the seller to make disclosures regarding lead paint. Therefore, a lead paint disclosure will be included in the disclosure list 408 if the property was built before that date. Similarly, disclosures may be included or not included in the disclosure list 408 based on the address of the property. As described herein, the document preparation system 100 may determine which disclosures to include in the disclosure list 408 for a particular property. Each disclosure included on the list may be associated with a completion status indicator 412A-n. The completion status indicator 412A-n may provide a visual indication to the seller regarding the associated disclosure form. For example, the checkmark of completion status indicator 4128 and completion status indicator 412D indicates the seller has successfully completed those two disclosures. The remaining completion status indicators have an “X” to indicate those disclosures have not yet been completed. In some example embodiments, the completion status indicators 412A-n may indicate a level of completion. For example, the completion status indicators 412A-n may indicate a number of questions remaining for each real estate disclosure. As an additional status indicator, the seller user interface 400 may include a status field 414 to visually indicate to the seller an overall level of completion. As illustrated by percentage field 416, the status field 414 indicates that the seller is X % complete with the real estate disclosure completion process. A status bar 418 indicates that user is less than halfway complete with the process. As is to be appreciated, the present disclosure is not limited to any particular technique for conveying a level of completion.

As illustrated, disclosure C has been selected by the seller. Accordingly, information related to disclosure C is displayed in the disclosure field 420. While the disclosure field 420 is illustrated as a component of the seller user interface 400, it is to be appreciated that this disclosure is not so limited. For example, in some example embodiments, the disclosure field 420 may be displayed in a separate window, such as a pop-up window. In any event, the disclosure field 420 may comprise a disclosure description field 422 and a data input field 423. The data input field 423 may generally include a question fields 424A-n and corresponding answer fields 426A-n. The answer fields 426A-n may allow the user to electronically provide answers to the questions, such as via graphical radio buttons, for example. In other example embodiments, other data input techniques may be used to receive the answers from the seller. Additionally, in some example embodiments, seller inquiry icons 436A-n may be associated with corresponding question fields 424A-n. While answering the questions, the seller may activate one or more of the seller inquiry icons 436A-n to indicate they have a question for the listing agent, for example. While answering the questions, the seller may also opt to save the current answers and return at a later time to complete the process.

Still referring to FIG. 4, the seller user interface 400 may also include a reference field 430. A plurality of links 432A-n may be presented within the reference field 430. The links 432A-n may allow the seller to access various reference materials, such as relevant federal statutes, state statutes, and other resources that may be helpful. The particular links 432A-n that are displayed in the reference field 430 may vary based on property. For example, if a link to state statutes is provided, the documentation preparation system 100 will determine the state in which the property is located and include a link to that state's statutes. The particular links 432A-n may also differ depending on the types of reference materials available for a particular type of transaction and depending on the questions being answered. For example, a link to an educational video may be available for a particular type of commercial real estate transaction. The link to that video would only be displayed to the seller if they were involved in that particular type of commercial real estate transaction. Furthermore, the reference materials available to the seller may be updated such that relevant and up to date informational materials may be provided to the seller.

As a seller navigates through the seller user interface 400, they may answer questions associated with each disclosure 410A-n in the disclosure list 408. Some disclosures will not necessarily require an answer to a question, but rather require the seller to read a statement or other type of disclaimer. In any event, as the seller accesses the various disclosures 410A-n and completes the actions required, the completion status indicators 412A-n and the status field 414 will be updated accordingly.

In various embodiments, as the seller is navigating the seller user interface 400, the document preparation system 100 may be logging the actions and storing the actions in a log file in the log database 126, for example. The log file may identify the events occurring during a user's interaction with the system, such as which documents have been viewed and/or completed, what questions were flagged, which reference resources were used, and so forth. In addition to the log file, or as part of the log file, the document preparation system 100 may also provide non-repudiation to the data. For example, the document preparation system 100 may be configured to provide proof of the integrity of the data (e.g., the tracking data). Along these lines, the document preparation system 100 may use digital certificates, for example. Additional tracking techniques, such as timestamps, may be used to actively log a user's interaction with the system and confirm a user's identity. In some embodiments, a user's IP address is recorded. Through the use of one or more digital authentication technique, the document preparation system 100 may establish that the proper user has navigated and completed the proper documents.

FIG. 5 illustrates a disclosure field 520 of a seller user interface in accordance with one non-limiting embodiment. As illustrated in FIG. 5, a data input field 523 may include questions 524A-F that have one or more target terms 534. The target terms 534 are words or phrases which may require additional explanation, for example. Upon receiving a target term definition request (e.g., the seller hovers the mouse over the target term, clicks on the term, etc.), a definition window 535 may be temporarily displayed to the seller. The data input field 523 may also comprise seller inquiry icons 536A-F associated with corresponding question fields 524A-F. The seller may access the individual icons and type notes for the listing agent, for example. Upon the seller answering the questions 524A-F using the answer fields 526A-F, an electronic document generation window 538 is presented to the seller. The electronic document generation window 538 indicates that an electronic version of the real estate disclosure document may be generated by the document preparation system 100 based on the answers provided in the answer fields 526A-F. In the illustrated embodiment, the seller may “click” the create PDF icon 540 to generate the electronic document. Before generating the electronic document, the document preparation system 100 may determine if all the questions have been answered, or if additional input is required from the seller for a question that has been answered. For example, various questions may require additional explanation from the seller if the seller answers the question with a certain answer. In some embodiments, the document preparation system 100 may highlight, or otherwise indicate, which questions or portions must be completed before an electronic document can be generated. Furthermore, once a electronic document is generated, should the seller update or otherwise change information, such as an answer to one of the questions 524A-F, the seller may re-generate an electronic document that includes the updated information.

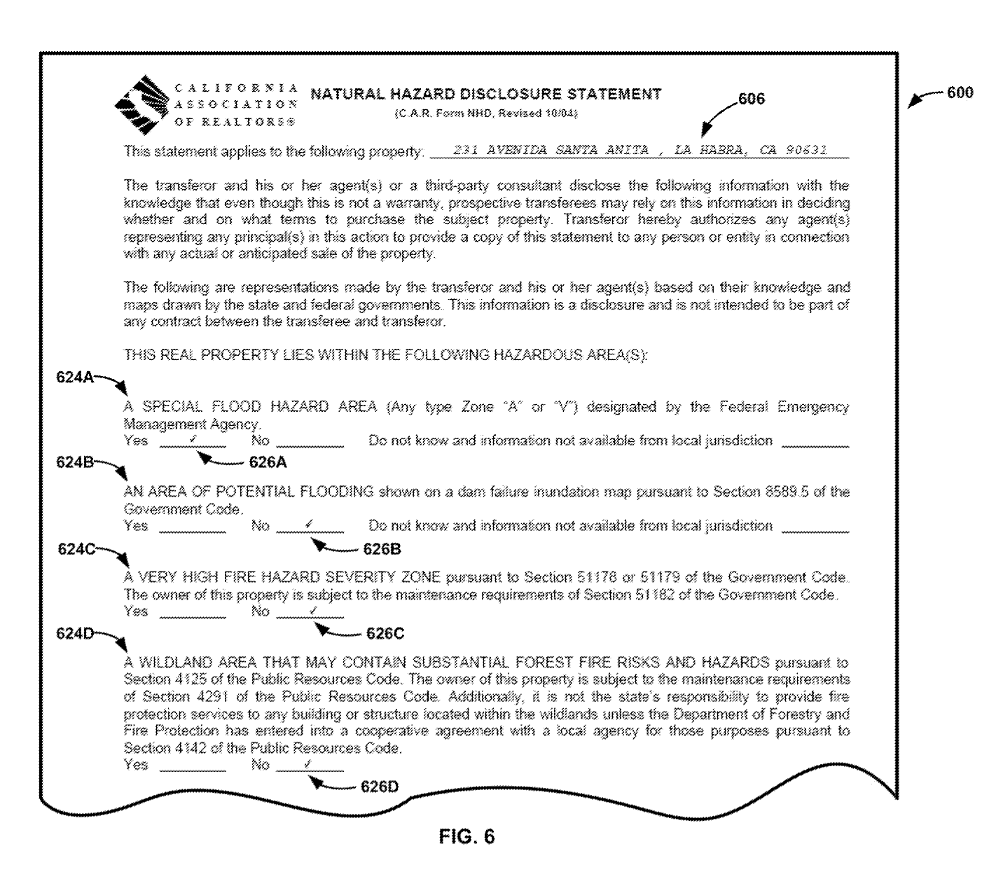

FIG. 6 shows a completed electronic real estate disclosure document 600 in accordance with one non-limiting embodiment. The completed electronic real estate disclosure document 600 is populated with data obtained via the answer fields 526A-F (FIG. 5). As shown, answers 626A-D are provided for each question 624A-D and the property address field 606 is populated with the address of the real property. The completed electronic real estate disclosure document 600 may subsequently be executed by the seller. In some embodiments, the questions in the question fields 524A-F may be written in a different language than the questions in the question fields 624A-D of the completed electronic real estate disclosure document 600. In other words, the questions in the question fields 524A-n (as presented to the seller) may be written in Spanish, for example, while the completed electronic real estate disclosure document 600 generated by the document preparation system 100 may be in English. Additionally, the question fields 524A-n that are presented to the seller may be grouped similarly or differently to the questions 624A-D on the disclosure document 600. In some example embodiments, the questions as presented to the seller may be logically grouped in a manner to increase accuracy and/or efficiency (e.g., grouped by subject matter, topic, etc.). The questions may then appear in a different order on the completed electronic real estate disclosure document generated by the systems.

FIG. 7 is shows a screen shot of a listing agent user interface 700 that a user may view when they access the document preparation system 100 from their user devices 130. The listing agent user interface 700 may be provided by the web server 131 or the application server 133, as the case may be, depending on the user's access method. In the illustrated embodiment, the listing agent user interface 700 is to be displayed to a listing agent of property (or other real estate professional) to convey information to the listing agent. It is to be appreciated, however, that the present disclosure is not limited to the arrangement and content of listing agent user interface 700 illustrated in FIG. 7. Unless otherwise indicated, the components with corresponding reference numerals to FIG. 4 (e.g., 402, 702) can have the same or a similar structure and function as discussed above with respect to other example embodiments. As such, these components will not be discussed in detail again, for the sake of brevity. Additionally, while the seller user interface 400 and the listing agent user interface 700 are illustrated with a large amount of visual similarity, it is to be appreciated that the disclosure is not so limited. In other words, in some example embodiments, the listing agent user interface 700 may be configured differently from the seller user interface 400.

The listing agent user interface 700 may generally convey information regarding the seller's completion status, among other details. For example, the listing agent may view the completion status indicators 712A-n to ascertain which disclosures 710A-n have been completed by the seller. The completions status indicators may be updated by the document preparation system 100 in accordance with the seller's activity. By selecting a particular disclosure (disclosure C is selected in FIG. 7), the listing agent may view the seller's answers to individual questions 724A-n. The seller inquiry icon 736A-n may indicate if the seller has a question, and by activating an icon, a seller question window 740 may be displayed to the listing agent. As illustrated, while the listing agent may be able to view the seller's answers in the answer fields 726A-n, the listing agent may not be able to electronically submit answers to the questions. Should the listing agent be viewing the listing agent user interface 700 as the user is completing the disclosures via the seller user interface 400, the listing agent may watch as the various questions are answered by the seller. In other words, as the document preparation system 100 receives an answer via the seller user interface 400, it may provide that information to the listing agent user interface 700. This information may be provided to the listing agent user interface 700 in real time, subject to standard delay of data propagating through networked systems.

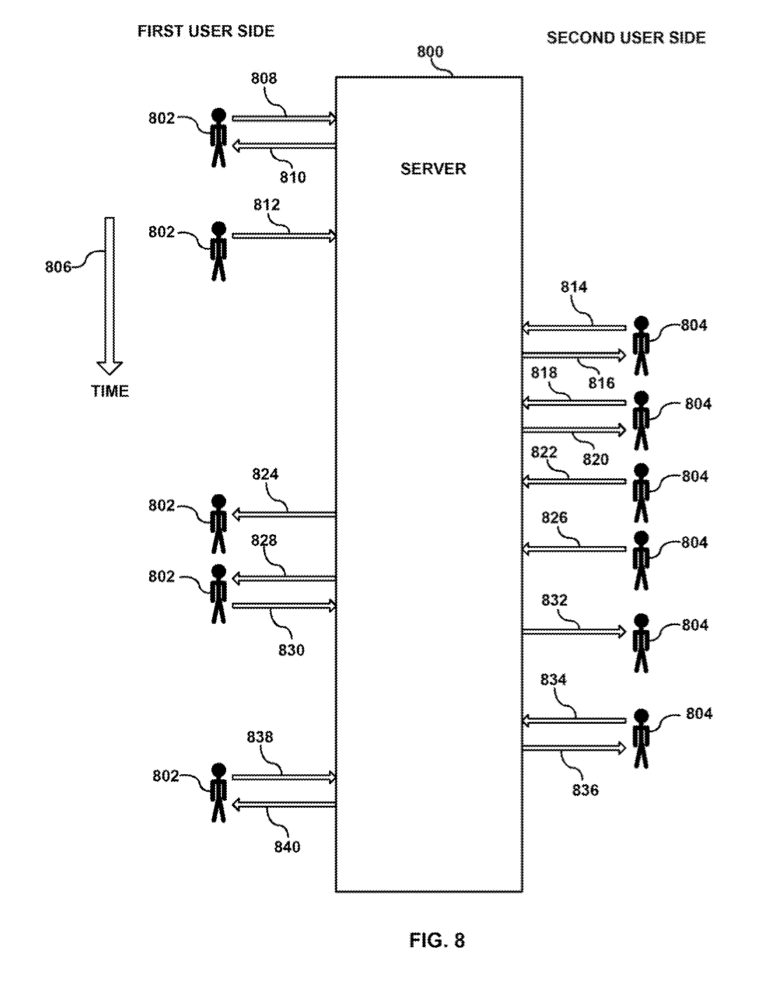

FIG. 8 is a time-base illustration of first user-side and second user-side interactions with a document preparation server 800 in accordance with one non-limiting embodiment. In one example embodiment, the first user 802 is a real estate professional, such as, a real estate agent, a broker, or a listing agent, for example. In one example embodiment, the second user 804 is a seller of a piece of real property, or someone who is otherwise knowledge about the property, for example. The passage of time is indicated by arrow 806. For simplicity, the document preparation computer server 800 is illustrated as a single element (e.g., a single computer-based server) in FIG. 8. As is to be appreciated, however, the server 800 may comprise a collection of various networked computer systems and devices, such as routers, servers, switches, and hubs, distributed across multiple geographic areas. The first user 802 and the second user 804 interact with the server 800 through their respective computer devices, such as a personal computer, a laptop computer, or a web-enabled mobile device, for example.

At 808, the server 800 may receive log-in credentials from the first user 802. At 810, a graphical interface may sent towards (e.g. served) to the first user 808 by the server 800. At 812, the server 800 may receives information from the first user 802 that uniquely identifies a piece of property (e.g., a piece of property the second user is offering for sale or otherwise desiring to sell). At 814, the server 800 may receive log-in credentials from the second user 804. In some embodiments, the server 800 may utilize the credentials from the second user 804 to authenticate the second user's interactions with the server 800. In one example embodiment, the second user 804 is authenticated, at least in part, based on their email address. For example, at 812 the first user 802 may have supplied an email address of the second user 804 to the server 800 in addition to the property data. The server may then send a notification to that email address requesting the second user 804 login to the server 800 to complete the necessary disclosure forms. In some embodiment, other techniques may be used to validate or authenticate, such as a social security number, PIN number, or other suitable technique. In any event, at 816, once the second user 804 is authenticated, a graphical interface is served from the server 800 to the second user 804. In some example embodiments, the graphical interface may be similar the seller user interface 400 illustrated in FIG. 4. At 818, the server 800 may receive a selection of a particular real estate disclosure document. At 802, the server 800 may server one or more electronics to the second user 804. At 822, the server 800 may receive an answer from the second user 804 corresponding to a question.

Referring now to the first user side, at 824, the server 800 may serve the answer of the question to the first user 802. In one example embodiment, the server 800 serves a graphical interface similar to the listing agent user interface 700 illustrated in FIG. 7. In this way, the first user 802 may electronically monitor the completion status of the second user 804. In some situations, the second user 804 may have a question for the first user. At 826, the server 800 may receive a question electronically submitted from the second user 804. At 828, the server 800 may serve the question to the first user 802. At 830, the server 800 may receive an answer from the first user 802 and pass the answer along to the second user 804 at 832. At 834, the server 800 may receive a generation document request from the second user 804. At 836, an electronic document may be served to the second user 804. The electronic document may incorporate answers received at 822, for example. In one example embodiment, the electronic document is similar to the completed electronic real estate disclosure document 600. The first user 802 may also request an electronic document. At 838, for example, the server 800 may receive a generation document request from the first user 802. At 840, an electronic document may be served to the second user 802 which is similar to the electronic document served to the second user 804 at 836.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A computer-implemented method for facilitating real estate document preparation corresponding to real property via a network, the method comprising:
receiving from a first user, by a computer system, real property data, wherein the real property data uniquely identifies the real property;
identifying, by the computer system, at least one uncompleted real estate document based at least partially on the real property data, wherein the at least one document comprises at least one question regarding the real property;
sending, by the computer system, toward a second user at least one electronic question corresponding to the at least one question on the uncompleted real estate document, wherein the second user has knowledge regarding the real property;
receiving from the second user, by the computer system, an electronic response to the at least one question; and
generating, by the computer system, an electronic document, wherein the electronic document comprises a completed real estate document suitable for execution by the second user.

2. The computer-implemented method of claim 1, wherein the first user is a real estate professional and the second user is a seller of the real property.

3. The computer-implemented method of claim 2, wherein sending toward the second user the at least one electronic question comprises:
sending toward the second use at least one target term in an at least one question field;
receiving from the second user, via a second graphical interface, a target term definition request;
upon receipt of the target term definition request, sending toward the second user a definition of the target term.

4. The computer-implemented method of claim 3, wherein sending toward the second user the at least one electronic question comprises:
sending toward the second graphical interface a plurality of electronic answer inputs.

5. The computer-implemented method of claim 4, wherein the plurality of electronic answer inputs are graphical radio buttons.

6. The computer-implemented method of claim 2, comprising:
sending, by the computer system, toward the first user a graphical display an indication of the electronic response to the at least one question by the second user.

7. The computer-implemented method of claim 2, comprising:
sending, by the computer system, toward the first user a status indicator, wherein the status indicator indicates a documentation completion status of the second user.

8. The computer-implemented method of claim 1, comprising:
generating, by the computer system, a log file indicating electronic actions taken by the second user; and
storing, by the computer system, the log file in a computer-based data storage system.

9. The computer-implemented method of claim 1, wherein the electronic document is suitable for execution by the second user.

10. A computer-implemented system for facilitating real estate disclosure document preparation corresponding to real property via a network, the system comprising:
a computer-based data storage system;
a computer system comprising at least one processor and operatively associated memory, wherein the computer system is in communication with the computer-based data storage system, wherein the computer system is programmed to:
receive from a first user real property data, wherein the real property data uniquely identifies the real property;
store the real property data in the computer-based data storage system;
identify at least one uncompleted real estate disclosure document based at least partially on the real property data, wherein the at least one disclosure document comprises at least one question regarding the real property;
send toward a second user at least one question field corresponding to the at least one question on the uncompleted real estate disclosure document;
receive from the second user an electronic response to the at least one question; and
generate, by the computer system, an electronic document, wherein the electronic document comprises a completed real estate disclosure document suitable for execution by the second user.

11. The computer implemented-system of claim 10, wherein the first user is a real estate professional and the second user is a seller of the real property.

12. The computer implemented-system of claim 11, wherein the computer system is programmed to:
send toward the second user at least one target term in an at least one question field;
receive from the second user a target term definition request;
upon receipt of the target term definition request, send toward the second user a definition of the target term.

13. The computer implemented-system of claim 11, wherein the computer system is programmed to:
authenticate an identify of the second user.

14. The computer implemented-system of claim 11, wherein the computer system is programmed to:
send toward the first user a status indicator, wherein the status indicator indicates a level of completion by the second user.

15. The computer implemented-system of claim 11, wherein the computer system is programmed to:
send toward the first user the electronic response to the at least one question by the second user.

16. A computer-implemented method for facilitating real estate disclosure document preparation corresponding to real property via a network, the method comprising:
generating, by a computer system, a graphical interface comprising an aggregation of indicia associated with corresponding real estate disclosure documents;
generating, by a computer system, a graphical status indicator associated with each real estate disclosure document;
upon receiving a selection of one of the real estate disclosure documents, identifying, by the computer system, a plurality of real estate disclosure questions to a user via the graphical interface, wherein the plurality of real estate disclosure questions are associated with the selected real estate disclosure document;
receiving from the user, via the graphical interface, an answer to one or more of the plurality of real estate disclosure questions; and
electronically generating, by the computer system, a completed real estate disclosure document, wherein the completed real estate disclosure document comprises at least the one or more answers received from the user.

17. The computer-implemented method of claim 16, wherein the user is a seller of the real property.

18. The computer-implemented method of claim 16, comprising:
upon receiving answers for each question in each of the real estate disclosure documents, transmitting, by the computer system, a completion notification.

19. The computer-implemented method of claim 16, wherein the real estate disclosure documents comprises at least one of a lead based paint disclosure form, a natural hazard disclosure form, a sellers affidavit, and a seller property questionnaire.

20. A non-transitory computer-readable medium for generating an electronic document, said medium comprising computer-executable instructions thereon for:
receiving from a real estate professional, by a computer system, real property data, wherein the real property data uniquely identifies the real property;
identifying, by the computer system, at least one uncompleted real estate disclosure document based at least partially on the real property data, wherein the at least one disclosure document comprises at least one question regarding the real property;
sending, by the computer system, toward a user at least one electronic question corresponding to the at least one question on the uncompleted real estate disclosure document, wherein the second user has knowledge regarding the real property;
receiving from the user, by the computer system, an electronic response to the at least one question; and
generating, by the computer system, an electronic document, wherein the electronic document comprises a completed real estate disclosure document.
